(19) United States
(12) Patent Application Publication
(10) Pub. No.: US 2018/0082236 A1
(43) Pub. Date: Mar. 22, 2018

(54) METHOD AND SYSTEM FOR PROVIDING CONSULTATIVE ANALYTICS IN A MULTI-TENANT SOFTWARE ENVIRONMENT

(71) Applicant: Tata Consultancy Services Limited, Mumbai (IN)

(72) Inventors: Viral Prakash Shah, Mumbai (IN); Gaurav Singh, Mumbai (IN); Chaitali Avinash Deshmukh, Mumbai (IN); Boddu Rakesh, Mumbai (IN)

(73) Assignee: Tata Consultancy Services Limited, Mumbai (IN)

(21) Appl. No.: 15/466,831

(22) Filed: Mar. 22, 2017

(30) Foreign Application Priority Data
Sep. 20, 2016 (IN) 201621032117

(51) Int. Cl. G06Q 10/06

(52) U.S. Cl. CPC G06Q 10/06393

(57) ABSTRACT

The disclosure generally relates to a reporting solution having capability of generating any type of visual report and more particularly to a method and system for providing consultative analytics in a multi-tenant software environment. The method is performed by registering a domain, wherein the domain represents the group of business entities in a process, creating a cube by defining dimensions belonging to the registered domain and defining relationships between the defined dimensions, wherein said cube is a dimension to dimension relationship, configuring report for said defined dimensions to fetch the data required for report generation and generating reports based on configured dimensions.

### PRIORITY CLAIM

This U.S. patent application claims priority under 35 U.S.C. § 119 to: India Application No. 201621032117, filed on Sep. 20, 2016. The entire contents of the aforementioned application are incorporated herein by reference.

### FIELD OF THE INVENTION

The disclosure relates generally to a reporting solution having capability of generating any type of visual report. More particularly, to a method and system for providing consultative analytics in a multi-tenant software environment.

### BACKGROUND

Generally, all the analytics solutions cater to domain specific requirements and there is no single software which can be utilized for any domain. The inventors here have recognized several technical problems with such conventional systems, as explained below. Currently, there is no single solution which can generate comparative analysis in different domains across different organizations. Also, there is no solution where user can design a single generic report format which can be utilized to generate reports analytics for any other user of same domain having similar requirement.

Thereby, providing consultative analytics in a multi-tenant software environment to provide for comparative analysis in different domains across different organizations where one organization can compare data with its own data or with the data of other organizations is still considered to be one of the biggest challenges of the technical domain.

### SUMMARY OF THE INVENTION

Embodiments of the present disclosure present technological improvements as solutions to one or more of the above-mentioned technical problems recognized by the inventors in conventional systems. For example, in one embodiment, a method for providing consultative analytics in a multi-tenant software environment is provided. The method comprises processor implemented steps of registering a domain, wherein the domain represents the group of business entities in a process using a domain registration module (202), creating a cube by defining dimensions belonging to the registered domain and defining relationships between the defined dimensions, wherein said cube is a dimension to dimension relationship using a cube creation module (204), configuring report for said defined dimensions to fetch the data required for report generation using a report configuration module (206) and generating reports based on configured dimensions using a report generation module (208).

In another embodiment of the invention, a system for providing consultative analytics in a multi-tenant software environment is provided. The system comprises of a processor, a data bus coupled to the processor and a computer-usable medium embodying computer code, wherein the computer-usable medium is coupled to the data bus and the computer program code comprising instructions executable by said processor and configured for operating a domain registration module (202) adapted for registration of domain, wherein domain represents the group of business entities in a process, a cube creation module (204) adapted for creation of a cube by defining dimensions belonging to the registered domain and defining relationships between the defined dimensions, wherein said cube is a dimension to dimension relationship, a report configuration module (206) adapted for configuration of report for said defined dimensions to fetch the data required for report generation and a report generation module (208) adapted for generation of reports based on configured dimensions.

In another embodiment, a non-transitory computer readable medium embodying a program executable in a computing device for providing consultative analytics in a multi-tenant software environment is disclosed. The one or more instructions which when executed by one or more hardware processors causes registering a domain, wherein the domain represents the group of business entities in a process using a domain registration module (202), creating a cube by defining dimensions belonging to the registered domain and defining relationships between the defined dimensions, wherein said cube is a dimension to dimension relationship using a cube creation module (204), configuring report for said defined dimensions to fetch the data required for report generation using a report configuration module (206) and generating reports based on configured dimensions using a report generation module (208).

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 shows a flow chart illustrating method for providing consultative analytics in a multi-tenant software environment, according to some embodiments of the present disclosure;

FIG. 2 shows a block diagram of a system for providing consultative analytics in a multi-tenant software environment, according to some embodiments of the present disclosure.

### DETAILED DESCRIPTION OF THE INVENTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described. In the following description for the purpose of explanation and understanding reference has been made to numerous embodiments for which the intent is not to limit the scope of the invention.

One or more components of the invention are described as module for the understanding of the specification. For example, a module may include self-contained component in a hardware circuit comprising of logical gate, semiconductor device, integrated circuits or any other discrete component. The module may also be a part of any software programme executed by any hardware entity for example processor. The implementation of module as a software programme may include a set of logical instructions to be executed by a processor or any other hardware entity.

The disclosed embodiments are merely exemplary of the invention, which may be embodied in various forms.

The elements illustrated in the Figures interoperate as explained in more detail below. Before setting forth the detailed explanation, however, it is noted that all of the discussion below, regardless of the particular implementation being described, is exemplary in nature, rather than limiting.

Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk.

The present disclosure provides a method and system for providing consultative analytics in a multi-tenant software environment. The solution described in the invention provides comparative analysis in different domains across different organizations, where one organization can compare data with its own data or with the data of other organizations.

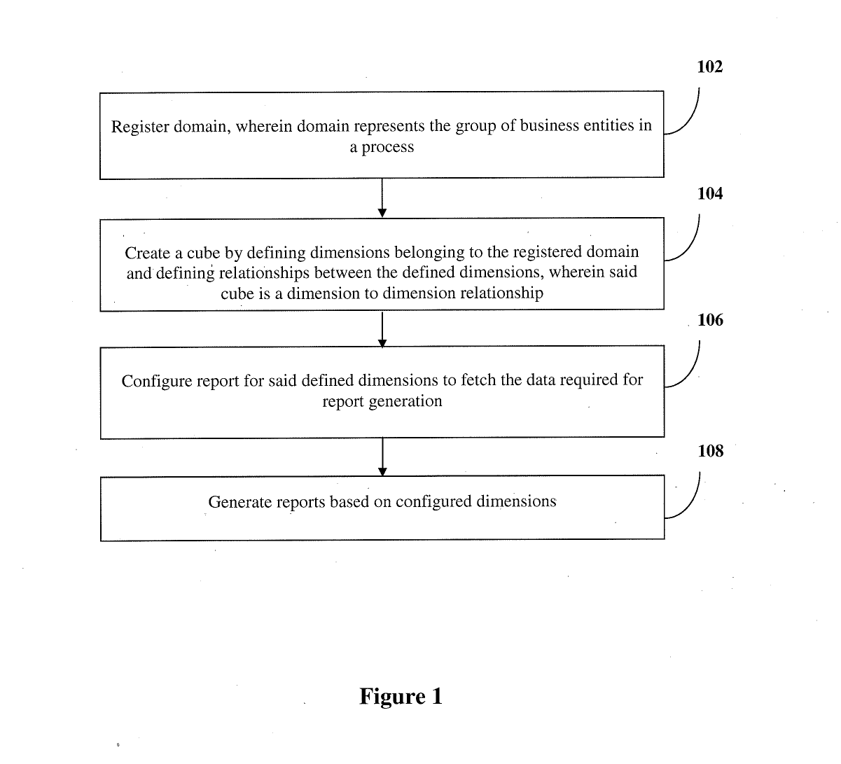

Referring to FIG. 1, it is a flow chart illustrating method for providing consultative analytics in a multi-tenant software environment.

The process starts at step 102, a domain is registered, wherein domain represents the group of business entities in a process. At step 104, a cube is created by defining dimensions belonging to the registered domain and defining relationships between the defined dimensions, wherein said cube is a dimension to dimension relationship. At step 106, report is configured for said defined dimensions to fetch the data required for report generation. Finally, at step 108, reports are generated based on configured dimensions.

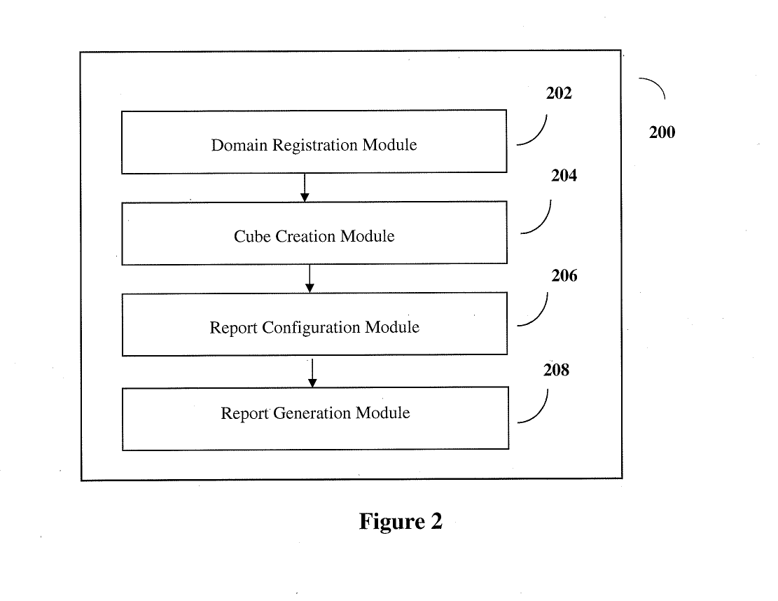

Referring to FIG. 2, it is a block diagram of a system for providing consultative analytics in a multi-tenant software environment. The system (200) comprises of a domain registration module (202), a cube creation module (204), a report configuration module (206) and a report generation module (208).

According to an embodiment of the invention, the method for providing consultative analytics in a multi-tenant software environment comprises of registering, a domain, wherein the domain represents the group of business entities in a process using a domain registration module (202), creating a cube by defining dimensions belonging to the registered domain and defining relationships between the defined dimensions, wherein said cube is a dimension to dimension relationship using a cube creation module (204), configuring report for said defined dimensions to fetch the data required for report generation using a report configuration module (206) and generating reports based on configured dimensions using a report generation module (208).

According to another embodiment of the invention, in the domain registration module (202), user can register a domain with system. The domain should be mapped with a particular application, wherein the application is an existing solution using which a user conducts daily transactions and the solution stores all the transactions data of the domain. The domain can be created for all organizations using the selected application or it can be created for a specific organization using that application.

According to another embodiment of the invention, in the cube creation module (204), a cube is created by defining dimensions belonging to the registered domain and defining relationships between the defined dimensions, wherein said cube is a dimension to dimension relationship. The dimensions are business entities of an organization and said dimensions may each have one to many relations. Dimensions are classified into two types—Level 0 dimensions are called as base dimensions (Independent Dimensions) and Level 1 dimensions are called as baseless dimensions. (Dependent Dimensions). For every dimension, user should provide an SQL query using to fetch data for the dimension. Once the domain and the dimensions are created, a user can create a relationship between one dimensions to other dimensions. The user can also modify the dimensions and its relationships.

According to another embodiment of the invention, in the report configuration module (206), report is configured for said defined dimensions to fetch the data required for report generation, wherein the report configuration module (206) further consists of creation of report, designing of report and uploading of template. First, a user selects the domain and enters report details and selects the base dimension for which report is to be generated. The user can also use pre-configured templates and then user can modify the pre-configured templates as per the requirement. Next, for designing of the report, the user adds dimensions as per the created cube, uses the appropriate query for said dimension, adds global and local variable to the query, wherein local variable fetches its value from parent query result set and global variable value is provided by user before generating report and validates the query for errors. User can add one or more dependent dimensions to the existing dimensions. Finally, for uploading the template, the user selects the domain name and report name and also provides for a description for the template.

According to another embodiment of the invention, in the report generation module (208), reports are generated based on configured dimensions, wherein the report generation module (208) further consists of defining value to global variable, defining report structure and generating final report. The generated report can contain any static or dynamic content or any graphical representation of data. In this module, user can generate reports using pre-defined report configurations. To generate a report, a user first selects domain and pre-configured report name using which report is to be generated. After selecting the domain and its report name, user selects the sample template and the excel sheet parameters, enter the details in the mandatory fields and generates the report.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for providing consultative analytics in a multi-tenant software environment, said method comprising processor implemented steps of:
registration of domain, wherein domain represents the group of business entities in a process using a domain registration module (202);
creation of a cube by defining dimensions belonging to the registered domain and defining relationships between the defined dimensions, wherein said cube is a dimension to dimension relationship using a cube creation module (204);
configuration of report for said defined dimensions to fetch the data required for report generation using a report configuration module (206); and
generation of reports based on configured dimensions using a report generation module (208).

2. The method of claim 1, wherein said domain should be mapped with a particular application.

3. The method of claim 2, wherein the application is an existing solution using which a user conducts daily transactions and the solution stores all the transactions data of the domain.

4. The method of claim 1, wherein said dimensions are business entities of an organization.

5. The method of claim 1, wherein said dimensions may each have one to many relations.

6. The method of claim 1, wherein for every said dimension, a user should provide SQL query using to fetch data for the dimension.

7. The method of claim 1, wherein configuration of report for said defined dimensions to fetch the data required for report generation consists of creation of report, designing of report and uploading of template.

8. The method of claim 1, wherein generation of reports based on the configured dimensions consists of defining value to global variable, defining report structure and generating final report.

9. The method of claim 1, wherein said generated report can contain any static or dynamic content or any graphical representation of data.

10. A system (200) for providing consultative analytics in a multi-tenant software environment, said system comprising:
a processor;
a data bus coupled to said processor; and
a computer-usable medium embodying computer code, said computer-usable medium being coupled to said data bus, said computer program code comprising instructions executable by said processor and configured for operating:
a domain registration module (202) adapted for registration of domain, wherein domain represents the group of business entities in a process;
a cube creation module (204) adapted for creation of a cube by defining dimensions belonging to the registered domain and defining relationships between the defined dimensions, wherein said cube is a dimension to dimension relationship;
a report configuration module (206) adapted for configuration of report for said defined dimensions to fetch the data required for report generation; and
a report generation module (208) adapted for generation of reports based on configured dimensions.

11. A non-transitory computer readable medium embodying a program executable in a computing device for providing consultative analytics in a multi-tenant software environment, the program comprising:
a program code for registration of domain, wherein domain represents the group of business entities in a process using a domain registration module (202);
creation of a cube by defining dimensions belonging to the registered domain and defining relationships between the defined dimensions, wherein said cube is a dimension to dimension relationship using a cube creation module (204);
configuration of report for said defined dimensions to fetch the data required for report generation using a report configuration module (206); and
generation of reports based on configured dimensions using a report generation module (208).
